(19) United States
(12) Patent Application Publication
(10) Pub. No.: US 2026/0301356 A1
(43) Pub. Date: Oct. 1, 2026

(54) SECURITY DOCUMENT VERIFICATION APPARATUS AND METHOD FOR EXAMINING A SECURITY DOCUMENT

(71) Applicant: VERIDOS GMBH, Berlin (DE)

(72) Inventors: Michal OCWIEJA, Dubai (AE); Mohammad MOUSA, Dubai (AE)

(21) Appl. No.: 19/489,388

(22) PCT Filed: Jun. 13, 2024
(86) PCT No.: PCT/EP2024/066436

§ 371 Date: Dec. 2, 2025

(30) Foreign Application Priority Data
Jun. 14, 2023 (DE) 10 2023 115 512.1

(51) Int. Cl. G06V 10/22; B42D 25/328; B42D 25/333; G06V 10/77

(52) U.S. Cl. CPC G06V 10/225; B42D 25/328; B42D 25/333; G06V 10/7715

(57) ABSTRACT

A security document verification apparatus includes a document scanning unit configured to scan a security document; a smart examining unit configured to automatically examine the provided at least one image; and an output unit configured to provide one or more security document feature levels and/or document forgery probability. A method is for examining security documents by using the security document verification apparatus and a computer-readable medium for causing a programmable processor to execute the method.

### FIELD OF THE INVENTION

The present invention relates to a security document verification apparatus, a method for examining security documents by using the security document verification apparatus and a computer-readable medium for causing a programmable processor to execute the method.

### BACKGROUND OF THE INVENTION

WO 2009/075 987 A2 provides techniques for identifying and validating security documents by applying a dynamic document identification framework. A security document authentication device includes an image capture interface that receives the captured images of a document to be identified and/or validated. The security document authentication device further includes a memory unit that stores a plurality of document types within a data structure given by the dynamic document identification framework. The security document authentication device also includes a document processing engine that traverses the captured image data by means of the data structure which is selectively invoked by one or by more of a plurality of processes. The processing engine identifies the captured image(s) as one of the pluralities of document type objects. This identification method is performed by traversing the data structure stored according to the dynamic document identification framework and provides identification results in a less efficient manner, because a given data structure has to be traversed on an element-by-element basis which consumes computing time and memory.

U.S. Pat. No. 11,594,053 B2 describes a deep-learning-based identification card authenticity verification apparatus for automatically checking authenticity of an identification card. The apparatus includes inputting identification card data to a feature information extraction model for the extraction of pieces of feature information. Further on, an indicator for checking authenticity of the identification card is expressed from the identification card data. The extracted pieces of feature information are put into a classification model for determination the authenticity of the identification card. When it is determined that the identification card is falsified a class activation map is extracted from the identification card data by means of the pieces of feature information. The class activation map shows and displays the falsification region of the identification card.

Presently, there are multiple solutions for automatic document examination including a physical device supported by the authentication software interworking with a reference document database and additionally with an authentication database. For instance, US 2022/0 207 901 A1 discloses a border control system that enables the validation of travel documents with artificial intelligence. This system comprises a document reader, a display, a keyboard, a database and a control. The document reader comprises a processor, a communication device, and a memory which includes an operating system, AI, self-learning validation modules, and other functional modules. The travel document is compared against the AI model, so the entire travel document is an input and the AI model outputs whether it is a potentially new document type or a potentially counterfeited document. Therefore, a document type is detected and if there is one or more new features spotted, those features are grabbed; used for future model training; and to confirm that this document type is new with xyz differences.

Applying this teaching to following example: Let us assume that there are three actual versions of a valid passport from country A. Version 1 of the passport is in that border control system and this can be detected and validated. Version 1 is already successfully trained with minor differences as similarity. If version 2 of the passport is detected, which is not in the system, but falls within the similarity of version 1, this system can find out that version 2 is similar to the version 1 and validates also version 2. If version 3 of the passport is detected, which is also not in the system, but falls not within the similarity of version 1, this system cannot validate version 3, because of too many or too large differences. This is because this approach is still relying on a document database.

These authentication software and related databases require a constant and time-consuming update, whenever new security documents to be examined are officially released or whenever new security features are introduced or enhanced for already known security documents. The automatic machine examination cannot be performed unequivocally in case the document is not yet included in the database and the authentication software is therefore not able to compare scanned and referenced features and give any result of the examination.

So, there is a need for a security document verification apparatus and a method for examining security documents that do not require reference document databases and/or authentication databases.

A primary object of the inventive security document verification apparatus is to enhance verification and authentication of security documents in a way that the examining process is not based on a time resource, computing resource and memory space resource consuming element-by-element comparison routine anymore.

### SUMMARY OF THE INVENTION

The above-identified objectives are solved by detecting security features and verifying their authenticity by means of predefined trained learning modules. The features of the inventive security document verification apparatus and its corresponding methods is given by the independent patent claims. Further advantageous embodiments are described in the dependent patent claims.

In an aspect of the present invention there is provided a security document verification apparatus which comprises a document scanning unit, a smart examining unit and an output unit.

The document scanning unit is configured to scan a security document to be analyzed and examined, meaning that the security document is scanned, or captured, or a picture is taken. A security document may be an (electronic) identification card, a passport, a visa, a residence permit, a driver's license, a social security card, a physical certificate or a bank note or another document of value (being a document that has a value that is higher than the substrate on which it is printed or arranged).

The scanning unit may be or may comprise a camera or another optical system, e.g. microscope, to scan the security document.

According to an aspect of the present disclosure the security document has one or more security features which are machine-readable and therefore being automatically further processable upon detection. As a prerequisite for automatically and instantly processing at least one image of the scanned security document is provided to the smart examining unit. More than one image of the security document may be further provided by the document scanning unit, e.g. subsequently or simultaneously.

Additionally electronic data as stored within the examined security document is received by the security data verification application for further processing and/or examination.

Electronic data as provided within the security document may be biometric data which may be extracted or read from an RFID chip by applying the appropriate frequency and coding schemes. Electronic data may also be personal data which is also stored within the RFID chip which is only readable for authorized units or users.

The stored electronic data may also be an attribute certificate, a digital signature, a digital representation of one or more security features (physically arranged) on or in the secure document, such as hologram as digital data or a picture as digital data or a photograph as digital data; each stored in the RFID chip. These electronic data may be read only by authorized users.

The stored electronic data is transferable from the RFID chip of the security document to the smart examining unit. For instance, the RFID Chip of the security document is read by chip reading unit, e.g. a smart card reader unit of the smart examining unit to receive the stored electronic data. These received data is then transferred for further examination with the smart examining unit.

The smart examining unit is configured to automatically and/or instantly examine at least one image as provided by the scanning unit. Each of the at least one of the security features is examined by applying a corresponding trained learning module. A corresponding trained learning module is a module which is automatically applied for the (detected) security feature. E.g. upon detection of this security feature, the trained learning module is invoked which is capable of examining the security feature in terms of its genuineness.

The inventions approach is that no reference documents and/or authentication database is required to examine the security document. The inventive examination process follows predefined routines and informs the person or machine which operates the inventive security document verification apparatus about the existence and the position of security features on the security document to be proved. An authenticity level of these security is maintained and displayed on an output unit. The probability of a forged security document may be additionally maintained and put out.

The present invention is de-attached from prior art restrictions such as time-consuming databases and updating of these databases. With this invention, no database of the documents per country or type is created but all security documents are scanned with the sole focus on security features. It means that it is possible to train the AI modules on any security document with genuine security features. Furthermore, by using one or more trained learning modules, security document feature levels and/or security document forgery probabilities can be provided. This is advantageous, because the behavior of a border control officer can be simulated in a much wider range.

Using the example presented in the background section above: It means that all three versions of the passport is scanned and even if not used to train the AI modules in the past, it is possible to extract security features and provide document feature level, e.g. in % and/or give probability of forgery, e.g. also in %.

The present invention provides an apparatus that outputs a probability for a security document or a security feature on/in the security document of being authentic or frauded. The invention is also giving a quantified indication of how secure the genuine security document is and how reliable is the manufacturing and the personalization process.

These security documents may be provided with at least one security feature, which is machine-readable. Such security feature can also be human-detectable.

Machine-readable security features may be the detection of a certain material used as a basis for the physical appearance of the security document. For example, a security document may consist of a predefined paper or of plastic like a distinctive polycarbonate material.

The paper of the security document may have certain properties, like a predefined thickness and/or brightness and the examining unit is configured to examine its thickness and/or brightness with a corresponding learning module. As another example, a surface structure of the security document, such as a paper surface or a plastic surface, may also be characteristic for the validity or authenticity of the security document and the examining unit may be configured to examine its surface structure with a corresponding learning module. The surface structure may comprise a defined number of lines per area, or a defined pattern as a machine detectable security feature. The nature of the surface roughness of the paper used for issuing the security document may also be a machine-readable security feature. Such security features may additionally be perceptible by humans examining and evaluating this security feature (or the security document) at first glance.

An exemplary machine-readable security feature may be a multiple laser image, MLI. An MLI includes a plurality of images within the same surface region, wherein the appearance of one or more images change with changing of a viewing angle.

An exemplary machine-readable security feature may be a changeable laser image, CLI. An CLI includes a plurality of colors, wherein one or more colors change with changing of a viewing angle.

Such MLI or CLI machine-readable security feature may be printed on a (polycarbonate) surface of the security document and may be provided with a plurality of notches. The nature of the notches may be a distinguishing feature eligible for the scanned security document.

The document scanning unit may be configured to scan the security document in high-resolution and/or ultra-high resolution, e.g. to determine and/or analyze the security feature, e.g. the MLI or the CLI. There are several options that are explained hereafter:

One option would be to scan the security document by taking a visible light image/picture from the security document, preferably in the region of the security feature such as MLI or CLI, and to analyze this visible light image without further optical enhancement of the scan. This option would be considered as scanning and analyzing the picture in normal resolution, e.g. with 400 dpi or lower.

Another option would be to scan the security document by taking a visible light image/picture from the security document, preferably in the region of the security feature such as MLI or CLI and to apply an optical magnification to analyze the security document, preferably in a region of the security features such as MLI or CLI, by applying an optical lens for zooming in order to obtain a high-resolution image/picture. This option would be considered as scanning and analyzing the picture in high-resolution which is higher than the normal resolution (without magnification), for instance the high-resolution being greater than 400 dpi, preferably greater than 500 dpi, more preferably 600 dpi.

Still another option would be to scan the security document by taking a visible light image/picture from the security document, preferably in the region of the security feature such as MLI or CLI and to apply an even stronger optical magnification to analyze the security document, preferably in a region of the security features such as MLI or CLI, e.g. by using a microscope for zooming in order to obtain an ultra-high-resolution image/picture. This option would be considered as scanning and analyzing the picture in ultra-high-resolution which is higher than the high resolution (with magnification) and also higher than the normal resolution (without magnification), for instance the high-resolution being greater than 600 dpi, preferably greater than 800 dpi, more preferably greater than 1000 dpi, most preferably 1200 dpi or higher.

In a preferred embodiment, to read MLI or CLI security features and to fulfill a need to have a high-resolution image from the document scanner, either a magnification of the security document is applied to obtain a high-resolution image for further analyzing or a microscope may be used as strong magnification to obtain an ultra-high-resolution image for further analyzing.

An exemplary machine-readable security feature may be a (microscopic) laser perforation pattern on arranged in a surface of the security document, e.g. provided as through holes in a paper substrate or in a plastic substrate defining the physical appearance of the security document.

An exemplary machine-readable security feature that may be also human detectable may be a hologram and/or a watermark, which may be further examined, e.g. by applying a conventional light source and/or a laser light.

The security document verification apparatus may receive electronic data and uses one or more corresponding trained learning modules to examine the corresponding security features. The received electronic data may be compared with one or more security features. So, the received electronic data may be compared with one or more of an ultraviolet light image, an infrared light image and a visible light image. For example, the examining unit may try to match and compare an image which is printed on the security document with electronic image data received from the RFID chip, e.g. using a face matching technique. For example, biometric data is detected by reading the RFID chip and the smart examining unit is triggered to automatically apply a corresponding examination learning module to compare the received biometric data with a security feature of the security document that corresponds to the biometric data, e.g. a passport picture or the like. This routine may be used for authentication purposes when the biometric features of a recently captured image of a passport holder is aligned with the security features of his security document, e.g., his passport. This comparison, e.g. at an immigration office at a border site, may result in positive authentication or in a failed authentication that may cause further steps to be processed by the border control unit.

Corresponding examination learning modules as a requirement for smart automatic examination of security features as provided with the security document may be one or more of the modules as listed below. This list may be extended in a non-limiting manner when future developments and its trained learning modules are wished to be implemented:

A trained learning module may correspond to analyze the security feature “paper” for detecting paper thickness or its surface roughness. For instance, the presence of a hinge, e.g. the top part of a security document sewed into a booklet and keeping the data page of the security document. For paper-based security documents, there is no hinge and the top part of the data page is paper whereas for polycarbonate-based security documents, the hinge is a special gap between the top part of the data page and the booklet binding.

As of today, paper-based substrates for the data page of a security document may be normal paper or artificial paper, such as Teslin.

A trained learning module may correspond to analyze the security feature “polycarbonate”, e.g. in view of its optical properties to extract its chemical substance composition for comparison with the learned reference composition.

As of today, passports as security documents may have thick or thin polycarbonate substrates for the data page. Alternatively, cards as security documents may have polycarbonate substrates, PET/PVC substrates and/or ABS and multipole other polymer substrates.

A trained learning module may correspond to analyze the security feature “laser perforation”. For instance, laser perforation parameters like geometrical design of the perforation holes or distance between holes or the like are examined.

A trained learning module may correspond to analyze the security feature “printed information”. For example, inkjet-printing parameters like the character or the scale of a font which is used within the security documents is observed and examined. The printed information also includes laser engraved information, punched information or other techniques to provide information in or on the security document.

A trained learning module may correspond to analyze the security feature “ultraviolet imagery”. For instance, a wavelength analysis is applied to identify an image. So, extracting artwork such as pattern visible under ultraviolet light from the data page of the document. Then the quality of those patterns can be verified by checking different colors and their characteristics. For example, red color in older documents becomes less visible than for the new document. It is further checked how the UV artwork appears on the data page.

A trained learning module may correspond to analyze the security feature “infrared imagery”. For instance, a wavelength analysis is applied to identify an image. Evidences can be found, which printing technology was used: laser printing or inkjet printing or both. Based on that any difference between printed text visible under UV and under IR can be examined.

A trained learning module may correspond to analyze the security feature “holographic overlay”. For instance, an holographic overlay parameter like the mirroring of a photograph is examined.

A further future trained learning module may be reserved for specialized and/or secret security features.

The corresponding trained learning module is selected and applied automatically upon detection of the associated security feature. For example, upon a hologram is detected as security feature, the smart examining unit selects the trained learning module “hologram”, applies it. It then calculates a probability for a genuine security feature and/or a probability for a forged security feature.

After detecting the hologram on the datapage following method may be applied: Verify the surface of the hologram to find any cracks or missing elements. Forgers of documents trying either to reuse the genuine hologram or to replace it with some dummy hologram. Hologram may have some artwork design and measuring the complexity of the detected hologram artwork may be applied. Wear and tear of the document is considered when checking the hologram, especially on the paper datapage.

The output unit of the security document verification apparatus is configured to provide a plurality of calculated probabilities for a genuine security document feature levels for each machine-readable security feature after applying the corresponding trained learning module.

Alternatively, the output unit of the security document verification apparatus may be configured to provide a plurality of calculated probabilities for a forged security document feature levels for each machine-readable security feature after applying the corresponding trained learning module.

The output unit of the security data verification apparatus may also be configured to simultaneously provide a probability for genuine security features and to provide a document forgery probability.

The smart examining unit of the security document verification unit is configured to detect a machine-readable security feature, like the character of a laser perforation in the security document by applying an image processing method on the image of the scanned or optically analyzed security document. One or more parameters are required for choosing the corresponding trained learning module to be applied for a verification of the detected security feature against learned patterns as provided by the trained learning modules.

Image processing methods (for example edge detection) are used together with computer vision techniques (for example object detection and/or image segmentation). The module was trained how to detect particular holes in the document datapage (visible under IR and maybe VL), extract them and merge together to read the “engraved” information.

The image processing method may be calculating a histogram of an image or determining its entropy or calculating its brightness or its distribution of brightness or simply interpolation.

The trained learning modules may be based on artificial intelligence technology like a deep learning scheme for example or like machine learning, neural networks, convoluted neural networks, computer vision, pattern recognition, knowledge engineering. For instance, computer vision, may be used.

The trained learning module is trained to analyze captured or scanned images of the scanned security document based on one or more of the following parameters.

In an embodiment of the security document verification apparatus, the document scanning unit may be configured to scan in a first wavelength region of the electromagnetic spectrum and the first wavelength region is the region of visible light, e.g. recognizable by a human.

Additionally, or alternatively, it may also be configured to scan in a second wavelength region which is an infrared light region. For instance, an IR image may become visible under IR light, but may be invisible under UV light or light in the visible spectrum.

Additionally, or alternatively, it may be configured to scan in an ultraviolet light region. For instance, an UV image may become visible under UV light, but may be invisible under IR light or light in the visible spectrum.

So, different images of the security document in different wavelengths are provided to detect and examine different kinds of security features.

Each of the different images provided by the scanning unit may be examined by an own trained learning module.

The output unit of the security document verifying may be configured to provide the one or more security document feature levels on a display unit. Alternatively, or additionally, it may also be configured to forward the document forgery probability to a backend-unit for conditioning the execution of further steps, like withdrawing a forged passport and denying to cross the border for the holder of the forged passport.

Two parameters are provided:

Document Security Features level (e.g. in %) to provide information about detected security features in the document.

Document Forgery Probability (e.g. in %)—for each security feature detected, probability of forgery in % is provided.

With a graphical user interface, the two parameters are display in user friendly mode to show security level of the scanned document together with probability of its forgery.

The invention further includes a method for examining secure documents using the inventive security document verification apparatus according to the embodiments as described above.

The method comprises the steps of scanning or capturing the security document to provide an image of the scanned security document or to detect electronic data as stored on the security document. A further step includes receiving and analyzing this electronic data in view of its classification and in view of its content.

After classification the provided image data and/or the electronic data are automatically examined the in view of detected security features by using one or more trained learning modules which correspond to detected security features to be further analyzed.

One or more security document feature levels as a percentage value are provided after evaluating the security feature by matching a pattern as provided by the trained learning module. The document feature level as a result of the evaluation may either be a successful or a failed detection. Whether there is a fail or success detection, a defined and configurable threshold is used. For example, for polycarbonate data pages, the threshold will be different from paper data pages.

A document forgery probability may also be determined by the inventive method.

Each trained learning module may provide one result, wherein a plurality of such results is organized or summarized within a vector or a vector structure which may be put out by the output unit.

The vector may be normalized by the number of components. For instance, each row may correspond to one distinct learning module (for one security feature) and it contains one result value for that security feature, e.g. in %. Putting all these values together means that the vector is normalized by the number of its components. In other words: If a passport datapage is scanned and multiple security features are recognized, it is now possible to verify each one of the security features against the examination learning module and give a percentage of its authenticity. Then, a threshold for each components value of the vector is established. Normalized means in this sense that if a certain security feature is not recognized in the security document (e.g. because this security document does not have that security feature), it is not added to the vector.

If the amount of vector as normalized by the number of its components (the amount of normalized vector) is greater than a defined threshold, the scanned security document is verified and/or authenticated. The normalization of the vector is necessary for a comparison of vectors or for a comparison of an amount of a vector with a threshold.

The invention also comprises a computer-readable medium with instructions stored thereon for causing a programmable processor to execute the method steps as described above.

### SHORT DESCRIPTION OF THE DRAWINGS

In the following, the invention or further embodiments and advantages of the invention are explained in more detail based on drawings, wherein the drawings describe only embodiments of the invention. Identical components in the drawings are given the same reference signs.

The drawings are not to be regarded as true to scale, and individual elements of the drawings may be shown in exaggeratedly large or exaggeratedly simplified form.

FIG. 1 shows an example of a document examination system according to the prior art;

FIG. 2 shows an exemplary embodiment of a security document verification apparatus according to the invention;

FIG. 3A shows an exemplary embodiment of a hardware unit within a security document verification apparatus according to the invention;

FIG. 3B shows another exemplary embodiment of a hardware unit within a security document verification apparatus according to the invention;

FIG. 4 shows an exemplary security document to be verified by the security document verification apparatus of the invention;

FIG. 5 shows an output screen of an output unit of a security document verification apparatus according to the invention;

FIGS. 6a and 6b each show an exemplary embodiment of a hinge for a polycarbonate-based security document;

FIGS. 6c and 6d each show an exemplary embodiment of a paper-based security document;

FIG. 7a shows an exemplary embodiment of a visible light image, an infrared image and an ultraviolet image of a part of a passport picture provided with an inkjet printing technique;

FIG. 7b shows an exemplary embodiment of a visible light image, an infrared image and an ultraviolet image of a part of a passport picture provided with a laser printing technique;

FIG. 8a shows an exemplary embodiment of a visible light image, an infrared image and an ultraviolet image of a part of a passport picture provided with an inkjet printing technique;

FIG. 8b shows an exemplary embodiment of a visible light image, an infrared image and an ultraviolet image of a part of a passport picture provided with a laser printing technique;

FIG. 9a shows an exemplary embodiment of an ultraviolet image of a part of a passport picture being examined as authentic; and

FIG. 9b shows an exemplary embodiment of an ultraviolet image of a part of a passport picture being examined as fraud.

FIG. 10 shows an exemplary embodiment of a vector of learning modules and corresponding results thereof in %.

### DETAILED DESCRIPTION OF INVENTIVE EMBODIMENTS

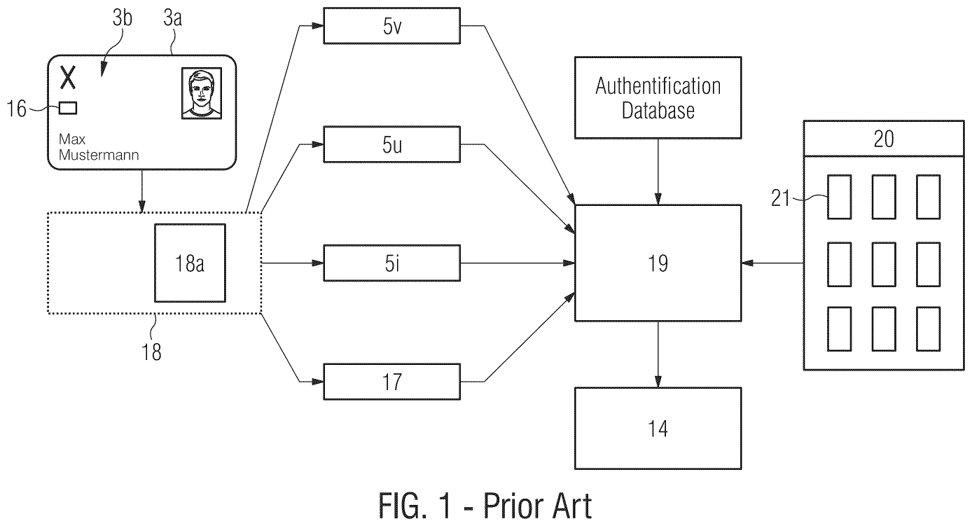

FIG. 1 shows an example of a document examination system according to the prior art.

An identity document 3a as an example of a security document 3 comprises a data page 3b as a top surface. On that data page 3a, one or more security feature 4 is arranged. The identity document 3a is placed on a scanning device 18 for performing document scanning 18a in three different wavelengths to scan the data page 3b. The document scanning 18a provides a visible light image 5v, an ultraviolet light image 5u, infrared light image 5i e.g., of the data page of the identity document 3a. In case a RFID chip 16 is disposed in the identity document 3a, a chip reading 17 is also performed by the scanning device 18.

As next step an authentication software 19 interworking with a reference document database 20 provides a result 14 after analyzing the provided visible light image 5v, ultraviolet light image 5u and/or infrared light image 5i in view of its genuineness or authenticity. For that purpose, the reference document database 20 contains reference identity documents 21 to be compared with the provided visible light image 5v, ultraviolet light image 5u and/or infrared light image 5i in view of certain document features. The result 14 may be a “successful verification” or a “failed verification” of the genuineness/authenticity of the identity document 3a. The result may be displayed as “Result OK”, “Result NOT OK” or as “No result available”. This result 14 may further be a prerequisite for an authentication of the identity document's holder in view of an already verified identity document 3a.

This existing automatic document examination system of FIG. 1 uses the authentication software 19, which comprises a dynamic document identification framework, which is interworking with the reference document database 20. Data structures of reference identity documents 21 of already known identity documents 3a, which are previously stored in the reference document database 20, are compared on an element-by-element basis with the elements of the provided visible light image 5v, ultraviolet light image 5u and/or infrared light image 5i.

As a drawback of the known system, when an identity document 3a is unknown to the system, the reference document database 20 must be updated first to enable the authentication software 19 to provide a plausible result 14. In case the unknown identity document 3a was not inserted in the reference document database 20, the result 14 would just display “No result” and no verification and/or falsification would be possible.

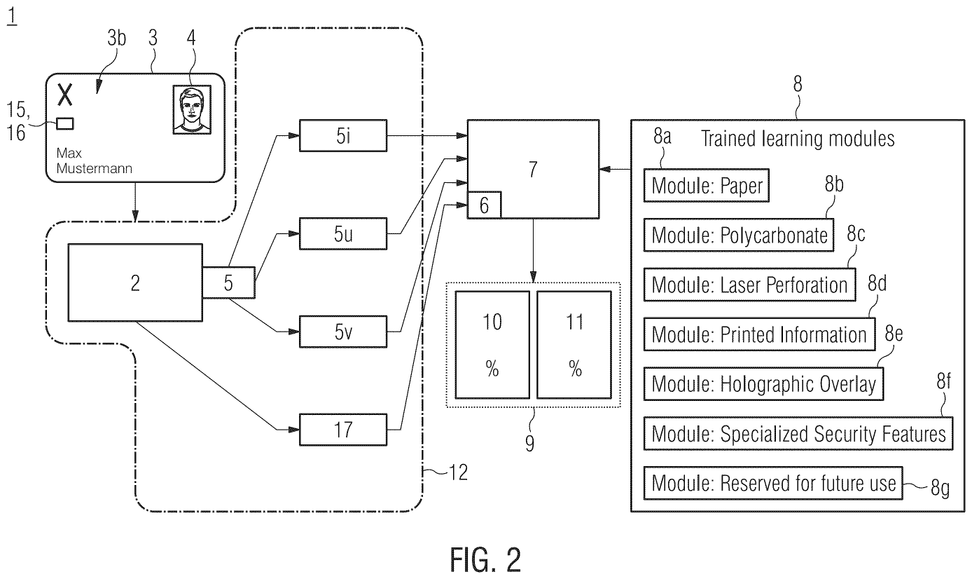

FIG. 2 shows an exemplary embodiment of a security document verification apparatus 1 according to the invention. The security document verification apparatus 1 comprises a document scanning unit 2, which is configured to scan a security document 3 having one or more machine-readable security features 4. The document scanning unit 2 is provided with three different image capturing units and their corresponding processing units each interfacing with a smart examining unit 7. The security document 3 may be a passport, an ID card, a visa, a residence permit, a driver's license, a social security card, a physical certificate, or a bank note. The document scanning unit 2 provides at least one of a visible light image 5v, an ultraviolet light image 5u and/or an infrared light image 5i of the scanned security document 3. Alternatively, or additionally electronic data 6 can be received by the accordingly configured document scanning unit 2 in case electronic data 6 is available and stored within the security document 3 and read by the chip reading 17. A storage unit 15 for the electronic data 6 may be a RFID chip 16. A security document 3 without electronic data 6 may additionally be scanned by the document scanning unit 2. These security documents 3 may be passports issued by countries which do not apply biometric data as a security feature 4.

The security document verification apparatus 1 further includes the smart examining unit 7 configured to automatically examine the provided image 5. More than one images can also be provided. The provided image(s) 5, 5v, 5u, 5i and/or the received electronic data 6 are analyzed instantly and/or automatically after scanning via the scanning unit 2 by using one or more trained learning modules 8. Each trained learning module 8 (here shown as different learning modules 8a to 8g) is configured to examine one or more corresponding security feature 4 of the security document 3. Each security feature 4 is machine-readable. Each security feature 4 is detected by the smart examining unit 7. Upon detection a corresponding trained learning module 8 is applied and an accordingly configured output unit 9 provides one or more security document feature levels 10 for each detected machine-readable security feature 4 after applying (executing) the corresponding trained learning module 8. Additionally, or alternatively a document forgery probability 11 for each machine-readable security feature 4 is provided after applying the corresponding trained learning module 8.

A trained learning module 8a is configured to analyze the security feature “paper” for detecting paper thickness or its surface roughness. This may include the analyzing of the paper color with the infrared light image 5u, the ultraviolet light image as well as the visible light image 5v. This may include the analyzing of other visible elements in (or on) the paper. This may include the analyzing of the paper to find security features, which can only exist on paper.

This may include the analyzing of a paper color with an infrared light image, an ultraviolet light image as well as a visible light image This may include the analyzing of other visible elements in or on the paper. This may include the analyzing of the paper to find security features, which can only exist on paper. For security documents, paper with different ingredient(s) compared to conventional paper may be used. For instance, paper of security documents may contain cellulose and cotton. So, security paper may lead to different reflection- or absorption-behavior, especially under ultraviolet or infrared light than other paper materials. In fake documents, paper is much brighter under UV light.

Additionally, watermarks in the paper and/or particles inside the paper, like: UV fibers or metallic thread visible under one or more of ultraviolet light 5u, infrared light 5i or visible light 5v, may be detected.

This may include the analyzing of the paper to find security features, which can only exist on polycarbonate.

This may include the analyzing of paper surface to detect a surface roughness, e.g. by analyzing images under ultraviolet light 5u or images under infrared light 5i to detect characteristics of the paper material that is used.

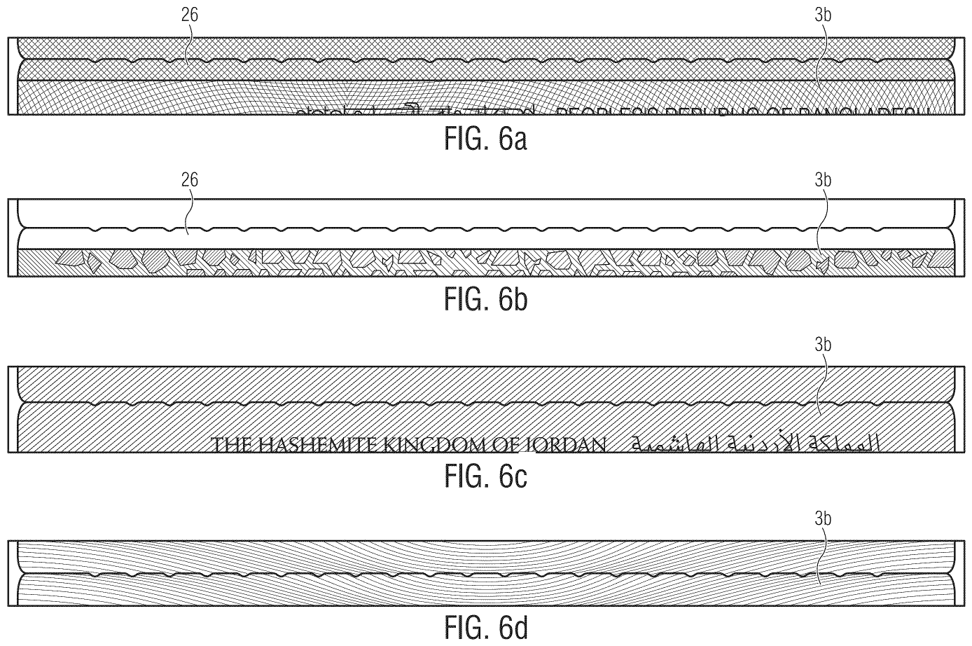

For instance, the presence of a hinge 26, as shown in FIGS. 6a to 6d, is analyzed. The hinge 26 refers to a top part of a data page 3b of a security document 3 sewed into a booklet and keeping the data page 3b of the security document 3. In FIGS. 6a and 6b, a hinge 26 is shown for a polycarbonate-based security document 3. Here, the hinge 26 is a special element adjacent to the data page 3b. In FIGS. 6c and 6d, there is no hinge shown, and so, it can be ruled that this security document 1 is a paper-based security document 3. There is no gap or step between top part of the data page 3b and the binding of the booklet.

Further applicable techniques for examining whether a paper-based or polycarbonate security document 1 is used is listed in following table:

| | | | Poly- | |
|---|---|---|---|---|
| | | Paper- | carbonate | Further techniques |
| No | Security feature | based | based | applicable |
| 1 | Hinge | | X | Detect plastic hinge, |
| | | | | classify |
| 2 | MLI/CLI area | | X | Detect MLI/CLI, |
| | | | | extract data |
| 3 | Laser main photo | | X | Detect main photo, |
| | | | | classify (VL, IR) |
| 4 | Main photo Color | X | X | Detect main photo, |
| | | | | classify (VL, IR) |
| 5 | Main photo holographic | | | |
| | overlay | | | |
| 6 | Main photo solid frame | X | X | |
| 7 | Main photo quality | | X | |
| 8 | Holographic foil | X | | |
| 9 | Perso MLI/CLI | | X | Detect MLI/CLI, |
| | | | | extract data |
| 10 | Perso Laser Perforation | | X | Detect Laser |
| | | | | Perforation |
| 11 | Perso Laser Perf. Passport | X | X | Decrypt Laser |
| | Number | | | Perforation Information |
| 12 | Holographic Thread | | X | Detect Holographic |
| | | | | Thread |
| 13 | Security Thread (inside | X | X | Detect Security Thread |
| | paper) | | | |
| 14 | Transparent Window | | X | Detect Transparant |
| | | | | Window |
| 15 | Personalization on OVI | | X | Detect OVI area |
| 16 | Graphical Personalization | | X | Extract Graphical Perso |
| | (Text) under VL or IR | | | from IR and compare |
| | | | | with VL |

As of today, paper-based substrates for the data page of a security document may be normal paper or artificial paper, such as Teslin. As of today, passports as security documents may have thick or thin polycarbonate substrates for the data page. Alternatively, cards as security documents may have polycarbonate substrates, PET/PVC substrates and/or ABS and multipole other polymer substrates.

A trained learning module 8b is configured to analyze the security feature “polycarbonate”, e.g. in view of its optical properties to extract its chemical substance composition for comparison with the learned reference composition. This may include the analyzing of the security document to find security features, which can only exist on polycarbonate.

A trained learning module 8c is configured to analyze the security feature “laser perforation”. For instance, laser perforation parameters like geometrical design of the perforation holes or distance between holes or the like are examined. For instance, a data page 3b visible under IR light gives the chance to see laser perforated holes. These holes may be arranged in a specific pattern, such as to provide user-readable information, such as letters, numbers and so on. Alternatively it is a machine-readable (coded) pattern. With the trained learning module 8c, it is possible to find holes in the images 5i, 5v, 5u of the data page 3b, extract these holes, classify and decode any information by merging all holes together. Classifying means that holes may have different shapes, such as squares, circles or triangles.

A trained learning module 8d is configured to analyze the security feature “printed information”. For example, inkjet-printing parameters like the character or the scale of a font which is used within the security documents is observed and examined. The printed information also includes laser engraved information, punched information or other techniques to provide information in or on the security document.

The trained learning module 8d can for instance detect an offset printing technique. Offset is widely used for all types of secure documents 1.

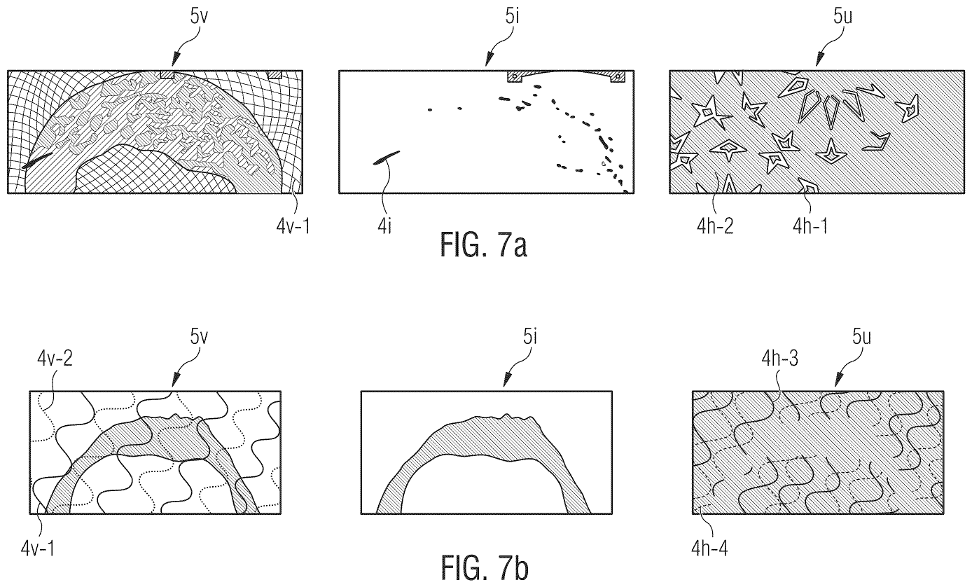

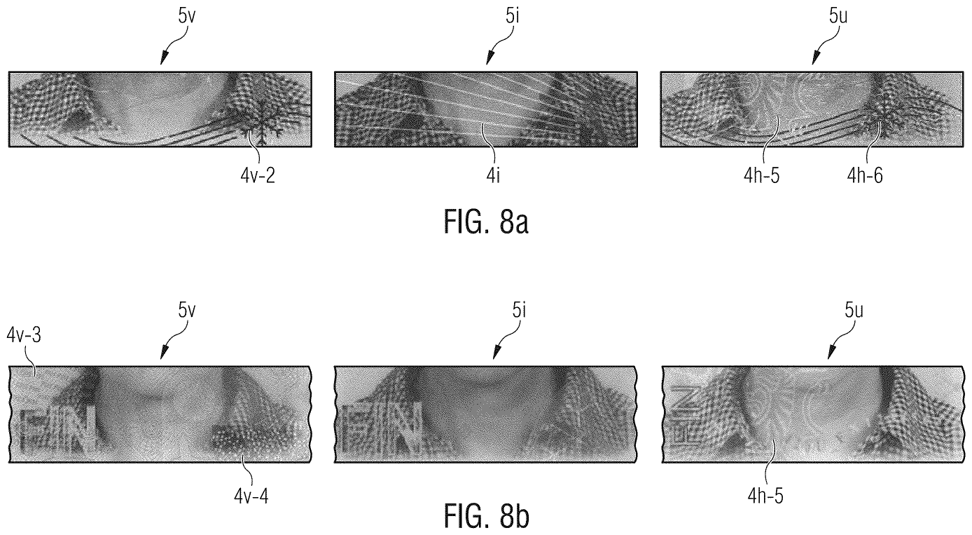

The trained learning module 8d examines the image quality under visible light, UV light and under IR light, resulting in images 5v, 5u and 5i, as for instance shown in FIGS. 7a to 9b. For a laser printing image, as shown in FIGS. 7b and 8b, the motive can be identified quite well in 5v and 5i. In contrast, in inkjet printing images, as shown in FIGS. 7a and 8a, visibility is highly dependent on the black ink, which is only visible as other inks Cyan, Magenta and Yellow and that cannot be under UV in 5u. Additionally, in the photo area, the patterns are quite different due to the used technologies, e.g.: laser printing gives a solid area and a very detailed image, whereas inkjet printing gives lower resolution compared to laser printing and it gives a specific pattern as the printing head of inkjet printer drops the ink whenever is needed—this technology is called Drop on Demand—DoD.

When the document is forged, usually the inkjet printing technique is used. The difference is clearly visible in the printing quality which can be classified using the module 8d.

A trained learning module 8e is configured to analyze the security feature “holographic overlay”. For instance, an holographic overlay parameter like the mirroring of a photograph is examined. Holographic overlay is visible under visible light and so, can be extracted from image 5i using the trained module 8e. For paper based datapage 3b it is required to protect the personalized data. For polycarbonate based security documents 3, a holographic logo is partially covering the main photo. This is to protect this photo from adding another photo on this layer. Holographic overlay can be extracted from the visible light image 5i. It can be measured with the module 8e, if the pattern was created using a machine and if this pattern is covering the whole datapage 3b.

A trained learning module 8f is configured to analyze a specialized and/or a secret security feature. Some of the security features 4 are secret and require specialized software to decrypt it. Such features, e.g. Jura IPI, or IAI ImagePerf, allow to read encrypted data either using dedicated lens or dedicated software solution to decrypt it.

A trained learning module (not shown in FIG. 2) may analyze a security feature “ultraviolet imagery”. For instance, a wavelength analysis is applied to identify an image. It is possible to extract the pattern of UV, colors, presence on some area, for example on MRZ or main passport holder photo. This will give the information if passport is secured enough using UV capabilities. Additionally, it can be estimated how old the document 1 is.

It is further checked how UV artwork appears on the data page, for example:

If the UV light is layered above a printed area, that means that the UV comes from the holographic overlay which was attached to the document surface after the personalization.

If the UV light artwork elements matches the visible light artwork elements, it means that one of the color used during the offset printing was UV active.

If UV brightness is too high (paper module result) and at the same time, no UV fibers are visible in the security document 3, the datapage 3b is not genuine.

Some of the techniques allows to print passport holder information under UV light. Once the UV module is used, it can be verified if those data are there (biographic data and/or photo).

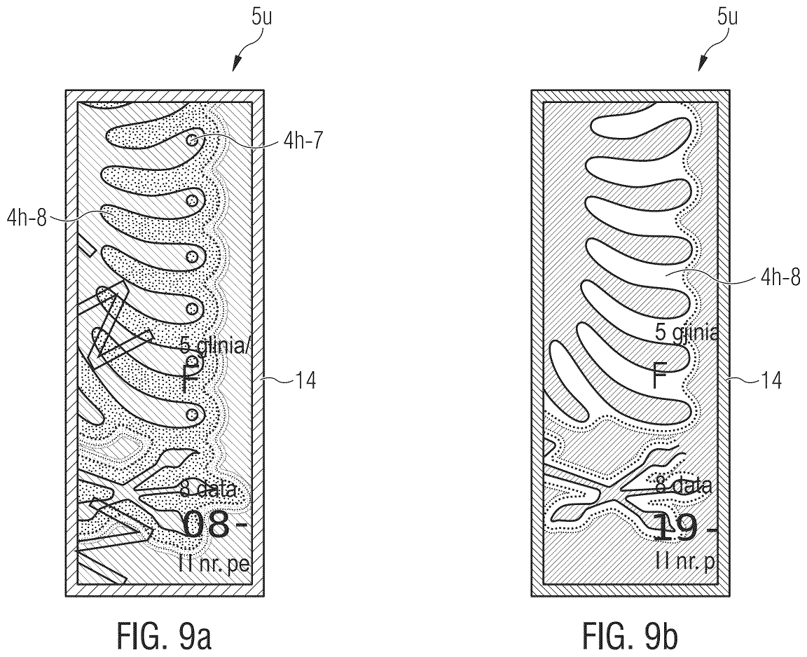

As seen from image 5u in FIG. 7a, the image 5u provides star UV pattern 4h-2 and diamond pattern 4h-1. As seen from image 5u in FIG. 7b, the image 5u provides first color line UV pattern 4h-3 and first color line UV pattern 4h-4. As seen from image 5u in FIG. 8a, the image 5u provides stamp UV pattern 4h-5 and snow star UV pattern 4h-6. As seen from image 5u in FIG. 8b, the image 5u provides stamp UV pattern 4h-5. As seen from image 5u in FIG. 9a, the image 5u provides wing pattern 4h-8 and dot UV pattern 4h-7. As seen from image 5u in FIG. 9b, the image 5u provides only wing pattern 4h-8. Since the dot UV pattern 4h-7 are missing in FIG. 9b, this security feature is considered as fraud and the result is “not authenticated”.

A trained learning module (not shown in FIG. 2) may analyze the security feature “infrared imagery”. For instance, a wavelength analysis is applied to identify an image. Evidence can be found, which printing technology was used: laser printing or inkjet printing or both. Based on that any difference between printed text visible under UV and under IR can be examined. This will help us to understand which technology was used to personalize the passport. In one country, some may use a wrong black ink in the passport personalization. None of the data was visible under IR light. Using this module, it can be found out what printing technology was used. IR wavelength allows to read the passport data page 3b—personalized text only—without artwork interruption. Additionally, it can be doublecheck if the main photo was printed using laser, as laser image is fully visible under IR, see image 5i of FIG. 7b or 8b. in comparison to image 5i of FIGS. 7a and 8a.

As seen from image 5i in FIG. 7a, the image 5i provides no photo but some artifacts 4i. As seen from image 5i in FIG. 7b, the image 5i provides the photo. As seen from image 5i in FIG. 8a, the image 5i provides stripe IR pattern 4i. As seen from image 5i in FIG. 8b, the image 5i provides the photo.

The invention is not restricted to the modules 8a to 8g as shown in FIG. 2. It is covered by the invention that the modules 8 contain more or even lesser modules 8 than shown in FIG. 2.

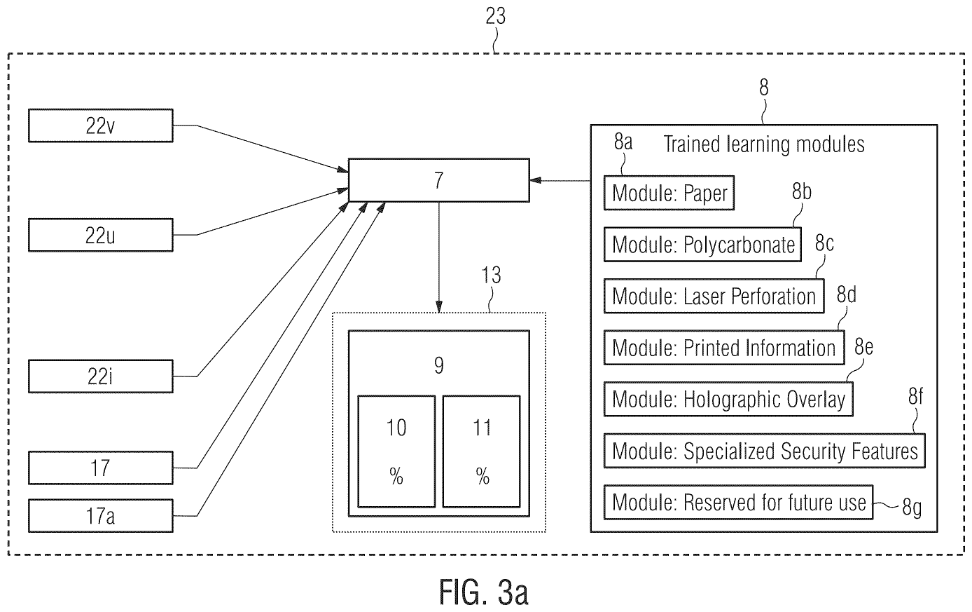

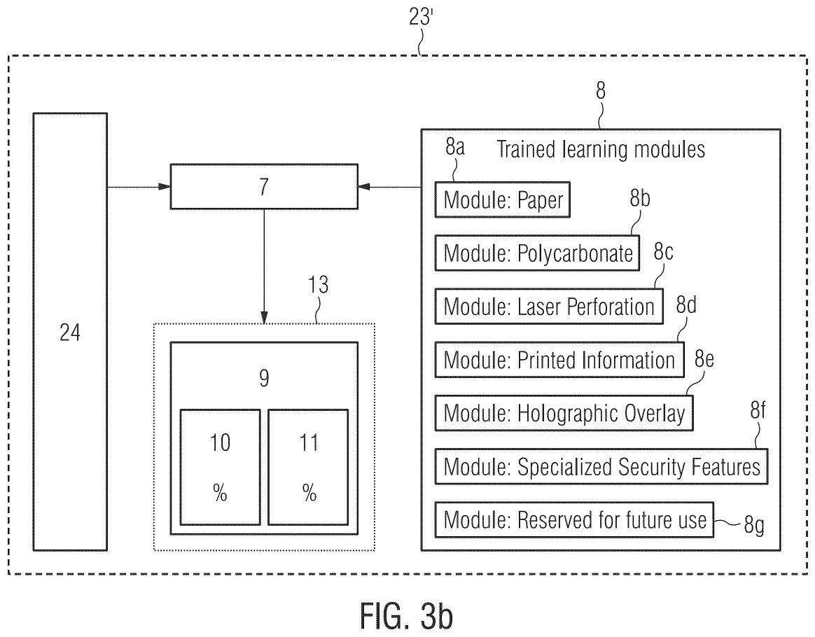

FIG. 3A shows an exemplary embodiment of a hardware unit 23 within a security document verification apparatus 1 according to the invention: The apparatus 1 includes three different image processing units 22v, 22u, 22i and a RFID chip reading 17 and data processing unit 17a. Each of these units 22v, 22u, 22i, 17, 17a, as well as the smart examining unit 7, the output unit 9 and the plurality of trained learning modules 8 may be implemented as software on one or more hardware units 23.

FIG. 3B another exemplary embodiment of a hardware unit 23′ within a security document verification apparatus 1 according to the invention. In contrast to FIG. 3A, only the smart examining unit 7, the output unit 9 and the plurality of trained learning modules 8 may be implemented as software on one or more hardware units 23′. The hardware unit 23′ is provided with an interface 24 through which the hardware unit 23′ receives the one or more images 5i, 5u, 5v from the respective one or more image processing units 22i, 22u, 22v.

In both FIGS. 3A and 3B, the output unit 9 is part of a display device 13 having a screen on which the security document feature level 10 and the document forgery probability 11 are displayed.

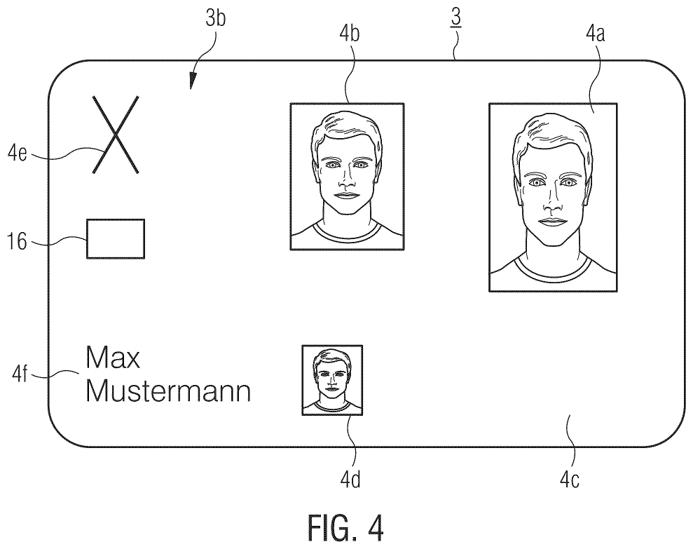

FIG. 4 shows an exemplary security document 3 to be verified by the security document verification apparatus 1 of the invention. Here, the security document 3 is an electronic ID card. This eID card is read and further processed for verification by the inventive security document verification apparatus 1. The eID card comprises several different security features 4 for instance a picture 4a showing a photograph of the eID card holder, a hologram 4b derived by mirroring the picture 4a, a RFID chip 16 and at least one MLI (or CLI) image 4d. The material of the eID card is a predefined polycarbonate 4c material or material composition. Another security feature 4 is a region 4e with a micro font, which is only readable by means of the document scanning device 2, e.g. a camera or another optical device. Another security feature 4 is a printed information 4f, that may be detected by optical character recognition methods.

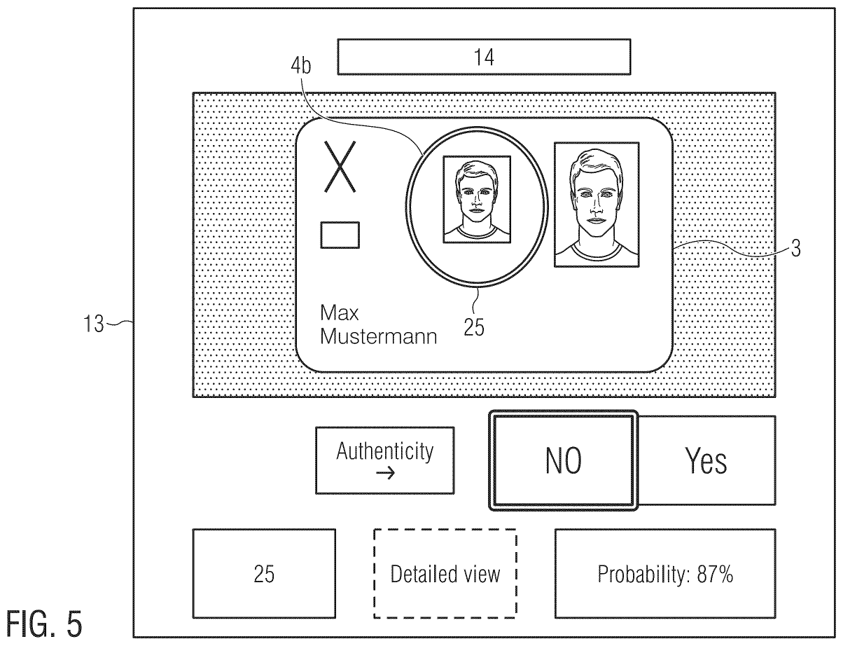

FIG. 5 shows a display device 13 showing an exemplary security document 3 as processed by the inventive security document verification apparatus 1. The display 13 shows the result 14 of a method for examining security documents 3 using the security document verification apparatus 1 as shown before.

In the shown example of FIG. 5, a falsification result 14 is put out. An image of the analyzed ID document 3 is also displayed in combination with the falsification region 25. In this case the security document verification apparatus 1 recognized the mirrored hologram 4b as forged, which is indicated by a framed “NO”. Alternatively (not shown in FIG. 5), the security document verification apparatus 1 may recognize the mirrored hologram 4b as valid, which could be indicated by a framed “YES”.

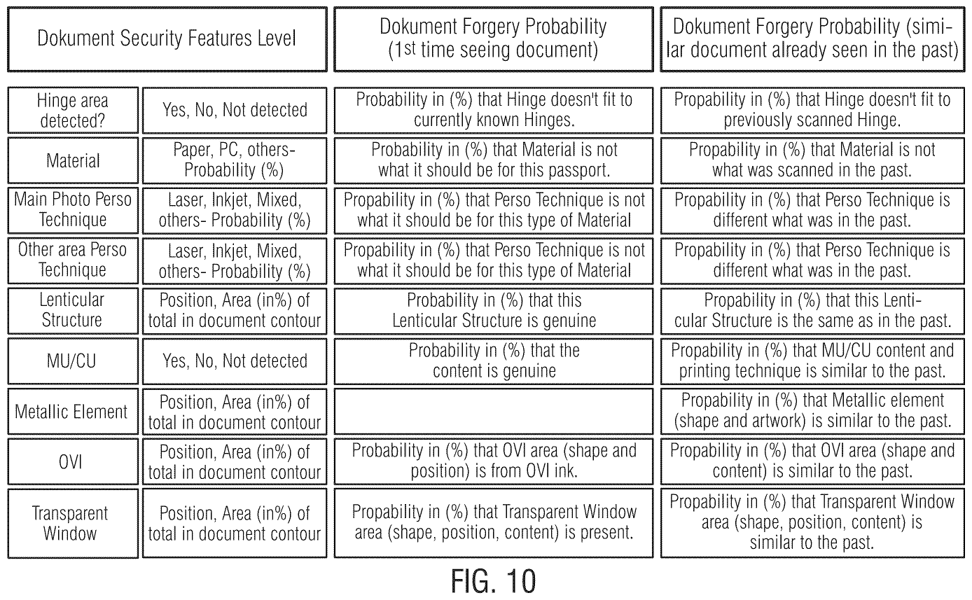

FIG. 10 shows an exemplary vector for learning modules 8a to 8g and corresponding results for security feature levels and forgery probability.

Each trained learning module 8a to 8g may provide one result, wherein a plurality of such results is organized or summarized within a vector or a vector structure which may be put out by the output unit 9.

The vector may be normalized by the number of components. For instance, each row may correspond to one distinct learning module 8a to 8g (for one security feature) and it contains one result value for that security feature, e.g. in %. Putting all these values together means that the vector is normalized by the number of its components.

If a passport datapage of a security document 3 is scanned, multiple security features 4 may be recognized. It is now possible to verify each one of the security features 4 against the examination learning module 7 and give a percentage of its (own) authenticity. For instance, in FIG. 10, the first column is dedicated to detecting a security feature 4 in a security document 3. The result of the detection is presented in the second column. The third column represents the forgery probability when the document is seen (is analyzed) the first time within the system. The fourth column represents the forgery probability when a similar document has been seen (is analyzed) in the past by the system before.

A threshold for each components value of the vector is established. Normalized means in this sense that if a certain security feature 4 is not recognized in the security document 3 (e.g. because this security document 3 does not have that security feature 4), it is not added to the vector. If the amount of vector as normalized by the number of its components (the amount of normalized vector) is greater than a defined threshold, the scanned security document 3 is verified and/or authenticated. The normalization of the vector is necessary for a comparison of vectors or for a comparison of an amount of a vector with a threshold.

### LIST OF REFERENCE SIGNS

1 security document verification apparatus
2 document scanning unit
3 security document
3a Identity document
3b data page
4 Security feature
4a picture (photograph)
4b mirrored hologram
4c polycarbonate material
4d Multiple laser image, MLI
4e Region with micro font
4f printed information
4g infrared pattern
4h ultraviolet pattern
4i visible pattern
5 image
5i Infrared light image
5u Ultraviolet light image
5v Visible light image
6 (received) electronic data stored within the security document
7 smart examining unit
8 trained learning modules
8a-8g individual trained learning modules
9 output unit
10 security document feature level
11 document forgery probability
12 detecting unit
13 Display device
14 Result
15 Storage unit
16 RFID chip
17 Chip reading
18 Scanning device
18a Document scanning
19 Authentication Software
20 Reference document database
21 Reference identity documents
22v Visible light image processing unit
22u Ultraviolet light image processing unit
22i Infrared light image processing unit
23, 23′ Hardware unit
24 Interface
25 Falsification region
26 Hinge

1.-15. (canceled)

16. A security document verification apparatus, comprising:
a document scanning unit configured to:
scan a security document having one or more machine readable security features to provide at least one image of the scanned security document and to receive electronic data stored within the security document;
a smart examining unit configured to automatically examine the provided at least one image and the received electronic data using one or more trained learning modules, wherein each of the at least one of the security features is examined by applying a corresponding trained learning module; and
an output unit configured to:
provide one or more security document feature levels for each machine-readable security feature after applying the corresponding trained learning module, and/or provide a document forgery probability for each machine readable security feature after applying the corresponding trained learning module.

17. The security document verification apparatus according to claim 16, wherein the one or more machine readable security features of the security document comprises at least one of the following:
a polycarbonate material,
a laser perforation,
a Multiple Laser Image, MLI,
a changeable laser imagery, CLI
a hologram,
a watermark,
a predefined paper type,
a holographic overlay,
UV activatable regions,
IR activatable regions,
a printed information,
a micro font.

18. The security document verification apparatus according to claim 16, wherein the smart examining unit comprises a detecting unit for determining the kind of security document and/or for determining the security feature.

19. The security document verification apparatus according to claim 16, wherein the smart examining unit is extendable with further trained learning modules for further security features.

20. The security document verification apparatus according to claim 16, wherein the smart examining unit is configured to:
detect the one or more machine readable security features in the security document by applying an image processing method on the at least one image of the scanned security document; and
extract one or more parameters required for the one or more trained learning module to verify the detected security feature against learned patterns from the trained learning modules.

21. The security document verification apparatus according to claim 16, wherein the trained learning module is based on an artificial intelligence deep learning scheme

22. The security document verification apparatus according to claim 16, wherein the trained learning module is trained to analyze the at least one image of the scanned security document based on one or more of the following:
paper security parameters;
laser perforation parameters;
inkjet-printing parameters;
ultraviolet security features;
infrared security features;
holographic parameters; and/or
specialized security features.

23. The security document verification apparatus according to claim 16, wherein the document scanning unit is configured to scan in a first wavelength region of the electromagnetic spectrum, the first wavelength region being the region of visible light; and/or configured to scan in a second wavelength region of the electromagnetic spectrum, the second wavelength region being an infrared light region; and/or configured to scan in a third wavelength region of the electromagnetic spectrum, the third wavelength region being a ultraviolet light region.

24. The security document verification apparatus according to claim 16, wherein the document scanning unit is configured to scan the security document in high-resolution and/or ultra-high resolution.

25. The security document verification apparatus according to claim 16, wherein the output unit is configured to provide the one or more security document feature levels and/or the document forgery probability on a display device and/or is forwarded to a backend-unit.

26. A method for examining security documents using a security document verification apparatus of claim 16, the method comprising the steps of:
scanning the security document to provide an image of the scanned security document and to receive electronic data (6) stored within the security document;
automatically examine the provided image and the electronic data in view of detected security features by using one or more trained learning modules which correspond to the detected security feature;
provide one or more security document feature levels and provide a document forgery probability.

27. The method for examining secure document according to claim 26, wherein the one or more security document feature level is determined as a result of an evaluation processed by a corresponding examination learning module for the security feature, whereas the result is either a successful detection of the security feature or a failed detection of the security feature,
wherein the result is provided as a percentage value.

28. The method for examining secure document according to claim 26, wherein each trained learning module provides one result,
wherein a plurality of results as evaluated by a smart examining unit are organized as a normalized vector output,
wherein the vector is normalized by the number of its components.

29. The method for examining secure document according to claim 28, wherein if the amount of the normalized vector is greater than a defined threshold, the scanned security document is verified and/or authenticated.

30. A computer-readable medium comprising instructions stored thereon for causing a programmable processor to execute the method steps of claim 26.
